(19) United States
(12) Patent Application Publication
(10) Pub. No.: US 2013/0088410 A1
(43) Pub. Date: Apr. 11, 2013

(54) NOTIFICATION DEVICE

(71) Applicants: Samuel Aaron HILL, Lafayette, IN (US); Thomas Casey Hill, Crystal Lake, IL (US)

(72) Inventors: Samuel Aaron HILL, Lafayette, IN (US); Thomas Casey Hill, Crystal Lake, IL (US)

(73) Assignee: RESEARCH IN MOTION LIMITED, Waterloo, ON (CA)

(21) Appl. No.: 13/269,346

(22) Filed: Oct. 7, 2011

(51) Int. Cl. G09G 5/00

(52) U.S. Cl. 345/1.1

(57) ABSTRACT

An electronic notification device can include a flexible exterior facing display screen and an electronic device coupler. The electronic device coupler can be configured to electrically couple the flexible display screen to an electronic device. The electronic device coupler can provide at least power to the flexible display screen from the electronic device. The electronic device coupler can also provide data to the flexible display screen from the electronic device. The flexible display screen configured to display a notification of receipt of a message. In one example, the flexible display screen is adapted to receive signals transmitted from the electronic device to display the notification via at least one of a Bluetooth connection, a near field communication connection, and a Wi-Fi connection. The electronic device coupler can be one of an induction coupler, a conductive contact pad, and a USB connector to provide power to the flexible display screen.

### FIELD OF TECHNOLOGY

The present disclosure relates generally to electronic devices and more specifically to a notification device for an electronic device, where the notification device can provide notification of information received by the electronic device.

### BACKGROUND

With the advent of more robust electronic systems, advancements of electronic devices are becoming more prevalent. Electronic devices can provide a variety of functions including, for example, telephonic, audio/video, and gaming functions. Electronic devices can include mobile stations such as cellular telephones, smart telephones, portable gaming systems, portable audio and video players, electronic writing or typing tablets, mobile messaging devices, personal digital assistants, and portable computers (such as tablet computers or laptop computers). Some of the electronic devices (including those just listed) can be portable, that is, readily transportable from place to place. Some of the electronic devices can be handheld, that is, sized and shaped to be held or carried in a human hand. Additionally, as electronic devices advance, so must the accessories that accommodate the electronic devices.

### BRIEF DESCRIPTION OF THE DRAWINGS

Embodiments of the present application will now be described, by way of example only, with reference to the attached Figures, wherein:

FIG. 1 is a front view of an exemplary electronic device associated with a notification device in accordance with an exemplary embodiment;

FIG. 2 is a perspective view of the electronic device illustrated in FIG. 1 housed in a notification device in accordance with an exemplary embodiment;

FIG. 3 is a side view of the notification device illustrated in FIG. 2, wherein a side of the notification device has been cutaway;

FIG. 4 is a front view of the notification device illustrated in FIG. 2, illustrating the an electronic device coupler of the notification device coupled to the electronic device housed therein;

FIG. 5 is a top view of a notification device in accordance with an exemplary embodiment of the present technology, wherein a flap portion of the notification device is in a first configuration displaying a first message;

FIG. 6 is a top view of the notification device illustrated in FIG. 5, wherein the flap portion of the notification device is in a second configuration displaying a second message;

FIG. 7 is a perspective view of the notification device illustrated in FIG. 6 illustrating the orientation of the flap portion with respect to an enclosing portion of the notification device;

FIG. 8 is a perspective view of the notification device illustrated in FIG. 5, wherein the flap portion is in a third configuration;

FIG. 9 is a perspective view of a notification device in accordance with another exemplary embodiment of the present technology, wherein the notification device include a plurality of light emitting diodes;

FIG. 10 is a top view of a notification device in accordance with a third exemplary embodiment of the present technology, wherein the notification device includes a wristwatch;

FIG. 11 is an illustration of the notification device illustrated in FIG. 10 in communication with an electronic device placed in the pocket of a user;

FIG. 12 is a perspective view of a notification device in accordance with a fourth exemplary embodiment of the present technology, wherein the notification device includes a computing device carrier; and

FIG. 13 is a perspective view of the notification device illustrated in FIG. 12 illustrating the electronic device coupler coupled to a computing device housed in the computing device carrier.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein.

Several definitions that apply throughout this document will now be presented. The phrase “communicatively coupled” is defined as connected, whether directly or indirectly through intervening components and is not necessarily limited to physical connections. The term “electronic device” is defined as any electronic device that is capable of at least accepting information entries or commands from a user. An “electronic device” generally includes its own power source (such as a rechargeable battery), although in some embodiments, an “electronic device” may receive power from an external source, such as an adapter or a charger.

The present disclosure relates to an electronic notification device that is configured to provide notifications of messages received by an electronic device electronically coupled to the electronic notification device. The electronic notification device can include an exterior facing display screen and an electronic device coupler. The electronic device coupler can be configured to electronically couple the display screen to the electronic device. The electronic device coupler can provide at least data to the display screen from the electronic device. The screen can be configured to display a notification of receipt of a message. For example, a message associated with the electronic device. In at least one embodiment, the electronic notification device can include a holster. Although various more specific embodiments may be described or claimed herein, the term “holster” is used herein for convenience, and may include a variety of devices that receive, hold or carry electronic devices, including a conventional holster, a briefcase, a laptop bag, a backpack, a laptop sleeve, an electronic pad cover, a carrying case, a handbag, or other carrier. In a typical illustrative embodiment, the electronic notification device can include a mobile phone holster, that is, a holster that is sized and shaped to receive, hold or carry a mobile phone. The holster can include a flexible display screen. In some embodiments, an electronic notification device need not include a holster, need not receive, hold or carry electronic devices, Although many described embodiments of holsters may enclose an electronic device (which includes but is not limited to totally enclosing the electronic device) some concepts may be applied beyond holsters, In a typical embodiment to be discussed below, an electronic notification device may be wrist-mounted (what will be referred to for convenience as a wristwatch, since it may be conveniently applied with conventional wristwatch functions), while the electronic device may be carried by a conventional holster, a pocket, or some other carrier. Other configurations and arrangements will be described below in relation to illustrated embodiments. One of ordinary skill would appreciate that the elements from the illustrated embodiments can be optionally included, combined, omitted, and arranged in various combinations to achieve the described benefits of the presently disclosed notification device.

Electronic devices can include a light emitting source, for example, a display screen, a light indicator, a light emitting diode, light bulb, a cathode ray tube, or other light emitting source. The light emitting source can be configured to display message, images, graphical images, or other visual notifications. Additionally, the light emitting source can emit light to provide notification signals, indicative of an incoming message, incoming information, received information, or other information received by the electronic device. When the electronic device resides in a conventional holster (for example, a holster, a purse, a pocket, a briefcase, or other holster), the display screen of the electronic device and light emitting sources of the electronic device are typically at least partially obstructed. As the display screen and light emitting sources are obstructed, the user can be prevented from receiving the visual notifications of an incoming message. In other words, when the electronic device resides in a conventional holster, visual notifications emitted from the light source may not be visible. As the visual notifications may not be visible through the holster, a user can miss incoming messages or can fail to receive a contemporaneous notification of the incoming message when it is received by the electronic device residing in the holster. An electronic notification device in accordance with the present disclosure can provide a notification of messages received by an electronic device which is stored or otherwise obstructed such that a user cannot view the visual notifications of the electronic device.

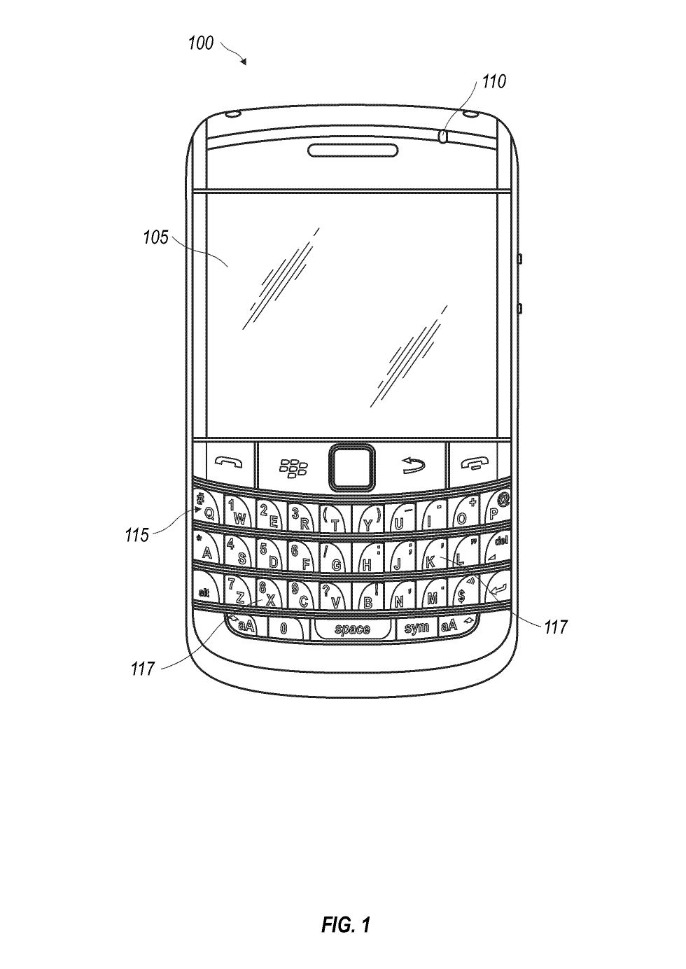

FIG. 1 is a perspective view of the front of an exemplary electronic device 100 that can be electronically coupled and/or communicatively coupled to the electronic device of the present disclosure. In general, two elements are communicatively coupled when one can communicate with the other. The communication may be, but need not be, two-way. Elements may be communicatively coupled by, for example, a wireless radio channel, an optical channel, or an electrically conductive path, or an optical cable path. While the components of FIG. 1 are not all inclusive, FIG. 1 illustrates components that can be included on an electronic device 100 for a notification device according to the present disclosure. Additional components are required to allow the mobile device 100 to function, but have been omitted for brevity and clarity. FIG. 1 illustrates an electronic device 100 that is a mobile phone. However, those of ordinary skill in the art will appreciate that the electronic device 100 can also be an electronic pad, a portable computing device, a personal digital assistant, a mobile navigation device, a laptop, a gaming device, a mobile messaging device, or other electronic device that can receive messages or information and transmit a notification signal indicative of the received message or information.

The illustrated electronic device 100 has a plurality of light sources. In FIG. 1, the light sources can include, for example, a display screen 105, an indicator light 110, and a keyboard 115. The display screen 105 can be a light crystal display (LCD), a light-emitting diode (LED) display, an active matrix organic light-emitting diode (AMOLED) display, a plasma display, or other display screen which can emit light and display visual information thereon. The indicator light 110 can be a light-emitting diode, a plurality of light-emitting diodes, and organize light-emitting diode, a quantum dot, an electron stimulated luminescence (ESL) lamp, a cathode ray tube, an electroluminescent wire, a solid state lighting element, or other light-emitting element which can provide visual notifications (for example, a blinking light, a flashing light, a light that can vary in brightness, or other visible notifications utilizing light).

The keyboard 115 can be an illuminable keyboard 115 comprising a plurality of illuminable keys 117. The keyboard 115 can be a full keyboard 115, having twenty-six keys 117 each associated with an alphabetic indicia, as illustrated in FIG. 1. Alternatively, the keyboard 115 can be a reduced keyboard, where at least one key 117 is associated with more than one alphabetic indicia. The keys 117 can be illuminable press-actuable keys, illuminable touch-sensitive keys, illuminable capacitive keys, or other similar illuminable key that allows for the input of data to a processor of the electronic device 100 upon user-engagement with the key 117. While FIG. 1 illustrates three light sources 105, 110, 115, those of ordinary skill in the art will appreciate that the electronic device 100 can include fewer or more light sources than illustrated, so long as the electronic device 100 includes at least one light source adapted to emit light when communicatively coupled to the electronic device 100. Those of skill in the art will also appreciate that light sources other than a display 105, an indicator light 110, and an illuminable keyboard 115 can be implemented. For example, other light sources can include an illuminable navigation tool, an illuminable function key, or other light source which can be communicatively coupled to the electronic device 100 and emit light.

The light source 105, 110, 115 can emit light to provide a user with visual notifications. The visual notifications can be an incoming message received by the electronic device 100. For example, the incoming message can be an email, a text message, a voice call, an instant message, a meeting notification, an alarm, an alarm clock, or any other message which the user of the electronic device 100 can be made aware of by a visual notification. The visual notifications can also be a new message(s), unread messages, read messages, missed calls, new voicemails, saved voicemails, or other messages which may be represented by a visual notification.

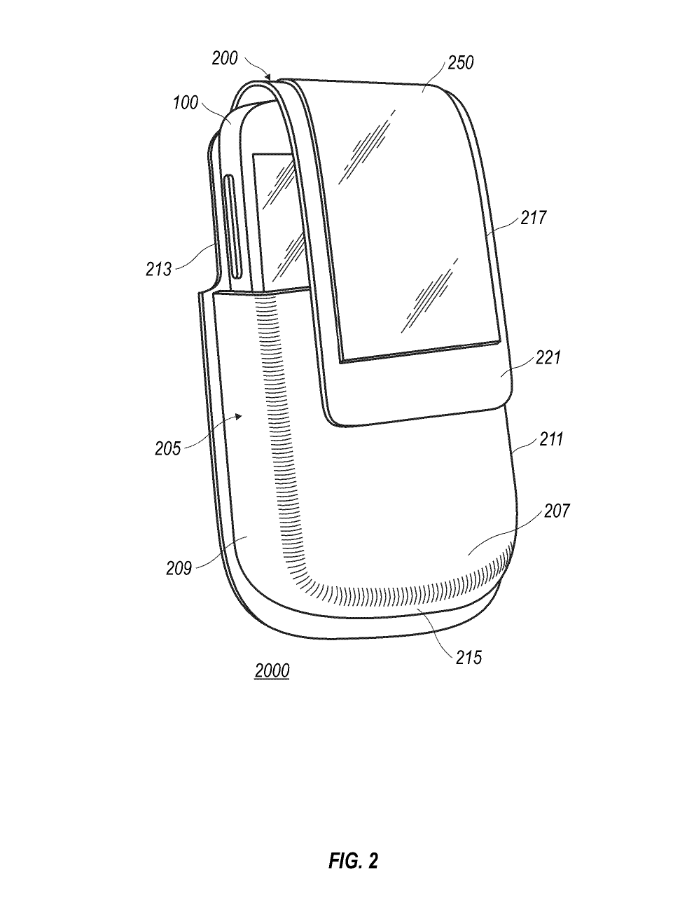

FIGS. 2-4 illustrates an exemplary embodiment of an electronic notification device 200 having an electronic device 100 residing therein. FIG. 2 is a perspective view of the electronic notification device 200. As illustrated in FIG. 2, the electronic notification device 200 is a holster. However, the electronic notification device 200 can also be a briefcase, a laptop bag, a handbag, a backpack, an electronic pad cover, a laptop sleeve, a wristwatch, or other carrier which can be coupled to a flexible display screen. In some embodiments, the electronic notification device 200 can be a carrier which can hold or retrain an electronic device and which can be coupled to a display screen communicatively coupled to the electronic device. The electronic notification device 200 illustrated in FIG. 2 can include an enclosing portion 205. For example, the enclosing portion 205. In at least one embodiment, the enclosing portion can have a front side 207, a bottom side 215, a first side (e.g., left side 209), a second side (e.g. right side 211), and a rear side 213. Also, illustrated in FIG. 2, the front side portion 207, bottom side portion 215, left side portion 209, right side portion 211, and rear side portion 213 are coupled to one another to form the enclosing portion 205. For example, the enclosing portion 205 can be a pouch, a pocket, or other portion which can receive an electronic device 100. The enclosing portion 205 can be formed from one piece of material or can be formed of multiple pieces of material.

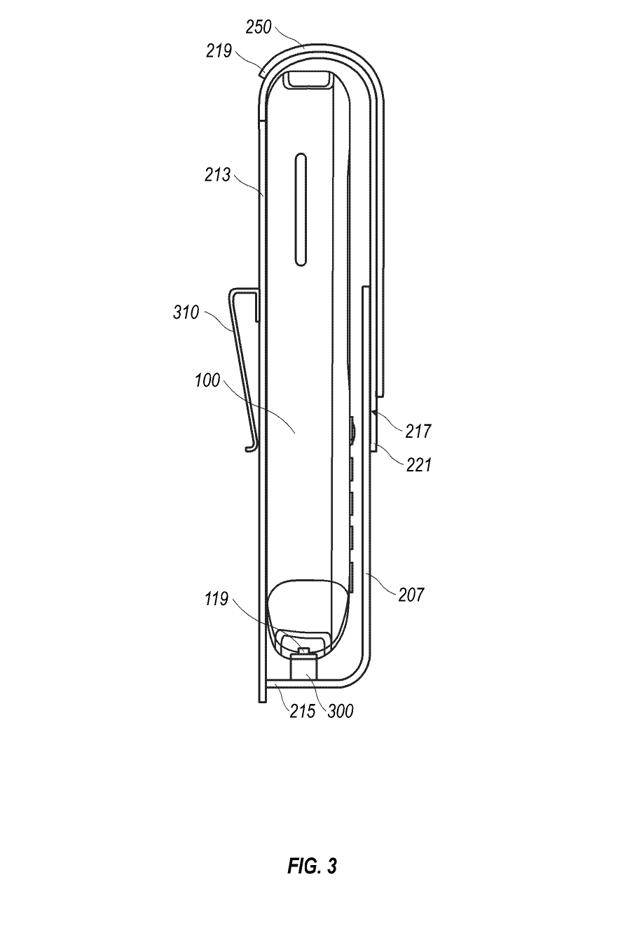

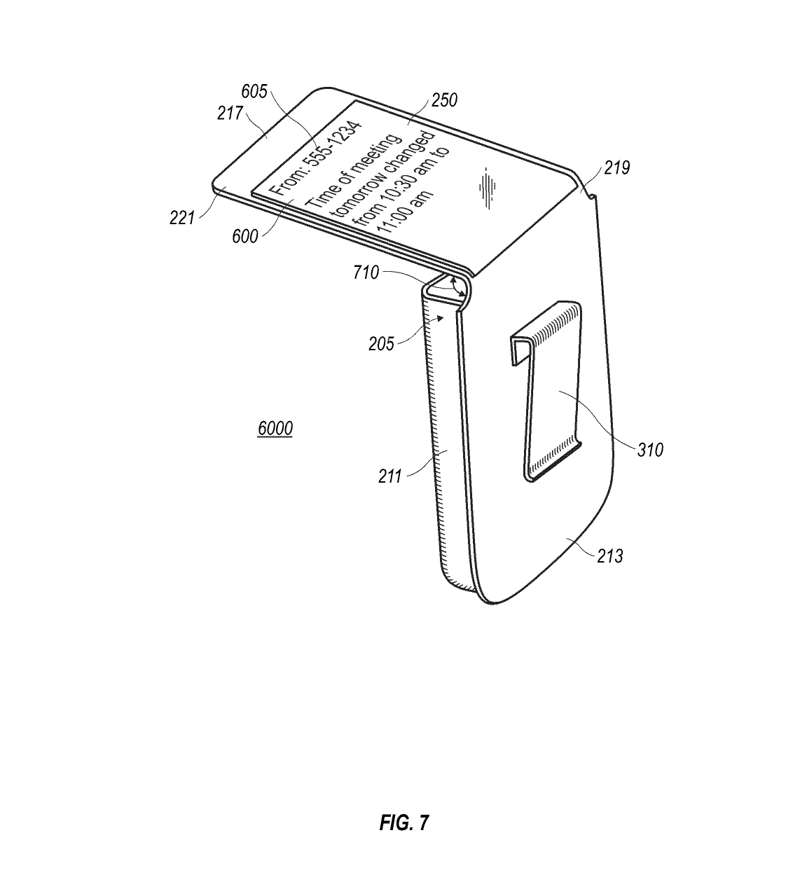

Also illustrated in FIG. 2, the notification device 200 can include a flap portion 217. The flap portion 217 can include a first end 219 and a second end 221 (shown in FIG. 3). The first end 219 can be coupled to the rear side portion 213 of the enclosing portion 205. The send end 221 can be releasably coupled to the front side portion 207. The flap portion 217 can be moveable between two positions: a first position 2000 (as shown in FIG. 2) in which the flap portion 217 is coupled to both the front side portion 207 and the rear side portion 213, and a second position 6000 (show in FIGS. 6 and 7) in which the flap portion 217 is coupled only to the rear side portion 213 of the enclosing portion 205. For example the first position 2000 can be a closed position, in which the flap portion 217 is coupled to the front side portion 207, thereby securing an electronic device 100 residing in the enclosing portion 205. The second position 6000 can be an open position in which the flap portion 217 is released from the front side portion 207, thereby enabling the electronic device 100 to be removed from the enclosing portion 205.

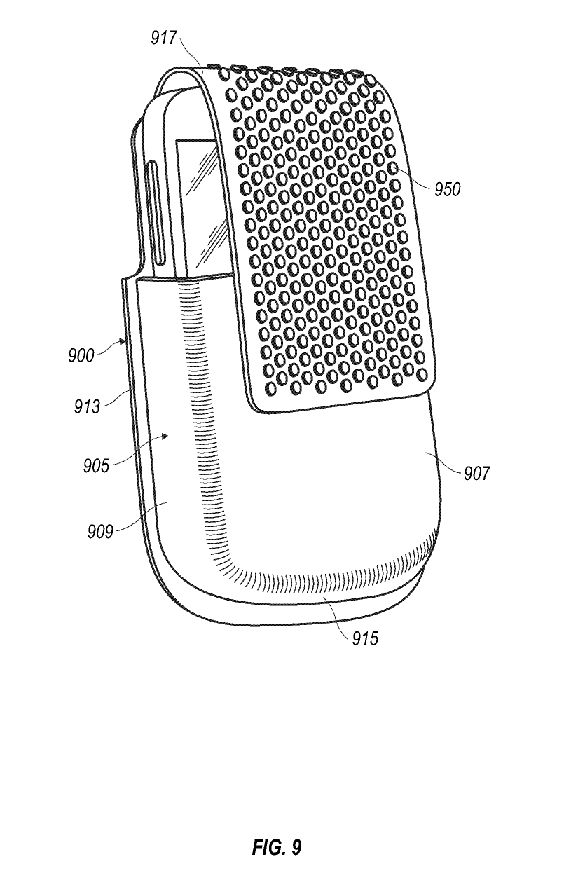

Also illustrated in FIG. 2, the electronic notification device 200 can include a flexible exterior facing display screen 250. The flexible exterior facing display screen 250 can cover a majority of the flap portion 217. For example, the flexible display screen 250 can cover approximately half of the flap portion 217, approximately three-quarters of the flap portion 217, one-quarter of the flap portion 217, ninety-five percent of the flap portion 217, the entirety of the flap portion 217, or any other amount of the flap portion 217 such that the flexible display screen 250 is large enough for a user to read notifications displayed on the display screen 250. The flexible exterior facing display 250 can be a flexible light emitting diode screen (LED), a flexible active matrix organic light emitting diode (AMOLED) screen, a flexible organic light emitting diode screen (OLED), a flexible light crystal display (LCD), a plurality of LEDs arranged in an array (shown in FIG. 9), a flexible substrate on which more than one transistor is placed thereon, an electronic paper display, or other display screen which can be coupled to the notification device 200 to display information such as notification messages.

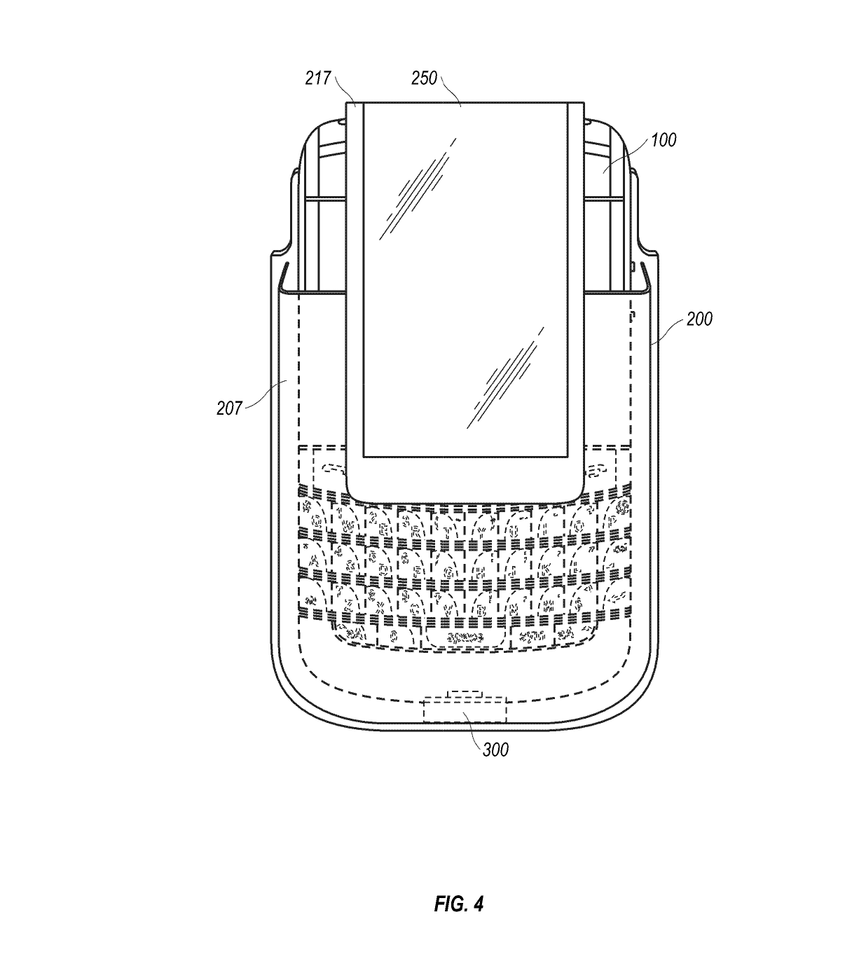

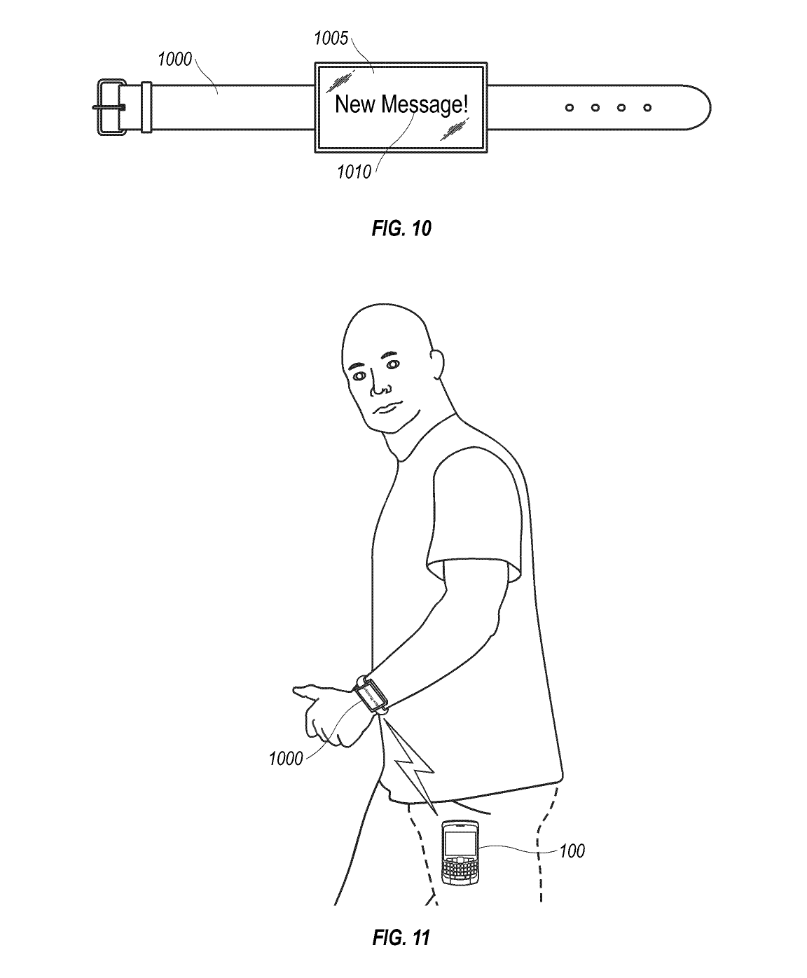

The electronic notification device 200 can include an electronic device coupler 300 (shown in FIG. 3). FIGS. 3 and 4 illustrate the electronic device coupler 300 more clearly. FIG. 3 is a side view of the electronic notification device 200 wherein a left side portion 209 of the notification device 200 has been cutaway to expose the coupling between the notification device 200 and the electronic device 100 residing therein. FIG. 4 is a front view of the electronic notification device 200 illustrating a front view of the coupling between the notification device 200 and the electronic device 100 residing therein, wherein the electronic device 100 is shown in phantom lines. The electronic device coupler 300 can be configured to electrically couple the flexible display screen 250 to the electronic device 100 inserted or residing in the enclosing portion 205. The electronic device coupler 300 can provide power to the flexible display screen 250 from the electronic device 100. In another embodiment, the electronic device coupler 300 can provide data to the flexible display screen 250 from the electronic device 100. In other embodiments, the electronic device coupler 300 can provide both data and power to the flexible display screen 250 from the electronic device 100. In FIGS. 3 and 4, the electronic device coupler 300 is coupled to the bottom side portion 215 of the enclosing portion 205. However, in other embodiments, the electronic device coupler 300 can be coupled to other portions of the enclosing portion 205. In FIGS. 3 and 4, the electronic device coupler 300 is a male power adapter configured for mating engagement with a female power receiver 119 of the electronic device 100. For example, the electronic device coupler 300 can be a male USB device configured for mating engagement with a female USB device 119 of the electronic device 100. In other embodiments, the electronic device coupler 300 can be a contact pad, an induction coupler, a conductive charging pad, a High-Definition Multimedia Interface (HDMI) connector, an inductive charging pad, or other electronic device coupler which can provide data, power, or both from the electronic device 100 to the flexible display screen 250. In another embodiment, an interior surface of the enclosing portion 205 can include a conductive coil (not shown) communicatively coupled to the flexible display screen 250, wherein, in the event an electronic device 100 is inserted into the enclosing portion 205, the conductive coil can generate power to be delivered to the flexible display screen 250 to power the flexible display screen. In another embodiment, at least one of the portions 207, 209, 211, 213, 215 of the enclosing portion 205 can include a wireless charging pad configured to provide power to the flexible display screen 250 from the electronic device 100. As the flexible display screen 250 can receive power from the electronic device 100 inserted into the enclosing portion 205, an independent power source for the flexible display screen 250 is not necessary. In such an embodiment, as one power source is required to power the flexible display screen 250 and the electronic device 100, power is efficiently utilized. When the electronic device 100 is inserted into the enclosing portion 205 and electrically coupled to the flexible display screen 250, the display screen of the electronic device 100 can be powered down, and the power that would have been otherwise used to power the display screen of the electronic device 100 can be used to power the flexible display screen 250. Thus, no additional power is consumed to power the flexible display screen 250. However, in other embodiments, the flexible display screen 250 can receive power from an independent power source electrically coupled to the electronic device 200 but not to the electronic device 100. Further details as to an independent power source electrically coupled to the electronic device 200 will be discussed in relation to FIG. 10.

Also illustrated in FIG. 3 is a securement member 310. The securement member 210 can be coupled to one of the portions of the notification device 200. For example, in FIG. 3, the securement member 310 is coupled to an exterior of the rear side portion 213 of the notification device 200. In other embodiments, the securement member 310 can be coupled to an interior or exterior surface of other portions (for example, a front side portion 207, a flap portion 217, a left side portion 209, a right side portion 211, or other portion) of the notification device 210. In FIG. 3, the securement member 310 is a belt clip. The belt clip can allow for the securement of the notification device 200 to a waistband or belt of a user. In other embodiments, the securement member 310 can be a strap, a belt loop, a chain, a rotatable or otherwise adjustable clasp, or other securement member coupled to the notification device 200 which allows the notification device 200 to be secured to the user or carried by the user.

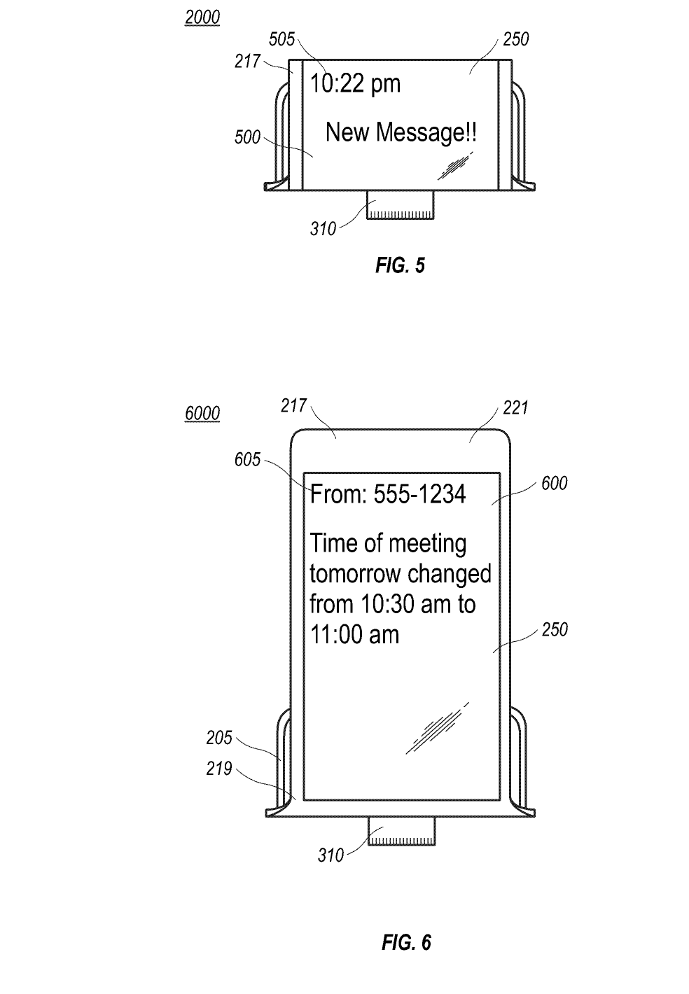

FIG. 5 illustrates a top view of the flap portion 217 of the electronic notification device 200 in which the flexible display screen 250 can display a notification 505 of a message received by the electronic device 100. For example, in FIG. 5, the notification device 200 is clipped to a user's waist, and the view illustrated in FIG. 5 is of the top of the flap portion 217 when the user looks down to the notification device 200 on his waist. When a message is received by the electronic device 100 when the electronic device 100 is coupled to the notification device 200 (for example, when the electronic device resides in the enclosing portion 205 of the notification device), a signal can be sent to the flexible display screen 250 to display the notification 505 that the message has been received by the electronic device. For example, the signal may be sent from a data port 119 of the electronic device 100 to a data port of the flexible display screen 250. In FIG. 5, the signal that a message has been received by the electronic device 100 can be transmitted to the flexible display screen 250 via the electronic device coupler 300. In other embodiment, the signal can be transmitted from the electronic device 100 to the flexible display screen 250 via a blue tooth connection, a near field communication connection, a wireless connection, a Wi-Fi connection, or other electronic communication that enables information associated with the electronic device 100 to be transmitted to the flexible display screen 250 of the notification device 200.

FIGS. 5-7 also illustrate an exemplary embodiment of an electronic notification device 200 in which the flexible display screen has a first power configuration (shown in FIG. 5) and a second power configuration (shown in FIGS. 6 and 7). The first power configuration can correspond to the first position 2000 of the flap portion 217. The second power configuration can correspond to the second position 6000 of the flap portion 217. In one example, the first power configuration can provide power to only a portion of the flexible display screen 250. In the second power configuration can provide power to an entirety of the flexible display screen 250. For example, when the flap portion 217 is in the first position 2000, wherein the electronic device 100 is secured within the enclosing portion 205, and a message is received by the electronic device 100, the flexible display screen 250 can be placed in the first power configuration where a first portion 500 of the flexible display screen 250 is powered. In this first power configuration, the flexible display screen 250 can be configured to display a notification 505 indicative of a received message by the electronic device 100, as illustrated in FIG. 5. For example, the notification 505 can be indicative of an incoming call, a voicemail, an email, a text message, a photo, or other message received by the electronic device 100. In one embodiment, the notification 505 can include a time and a type of message received, an indication of a number of emails received, a name or a phone number associated with the message received, a name and/or phone number of an incoming call, a subject line of a message received by the electronic device 100, a number of missed calls, a number of voicemail message, or any other notification 505 associated with the message received by the electronic device 100.

When the notification 505 is received, the flap portion 217 can be placed in the second position 6000, illustrated in FIGS. 6 and 7, and the flexible display screen 250 can be placed in the second power configuration in which the entirety 600 of the flexible display screen 250 is powered. In this second power configuration, a detailed view 605 of the message can be displayed on the flexible display screen 250. For example, the detailed view can be a body of an email or a text message, a portion of an email or a text message, a subject line of a text message, a call log of missed calls received by the electronic device 100, a photo or other multimedia message received by the electronic device 100, or any other detailed portion of the message.

For example, in FIGS. 5 and 6, the notification device 200 can be clipped to the waistband or belt of the user. For example, in FIGS. 5 and 6, the notification device 200 is can be clipped to the user by a belt clip 310. When the user views the notification 500 when the flap portion 217 is in the first position, the user can then release the flap portion 217 from the front side portion 207. In one embodiment, the user can lift the flap portion 217 from the front side portion 207 of the enclosing portion 205 such that the flap portion 217 forms an angle 710 with respect to the rear side portion 213 of the enclosing portion, as illustrated in FIG. 7. For example, the flap portion 217 can be lifted for form substantially a ninety degree angle, a sixty degree angle, a forty-five degree angle or any other angle greater than zero with respect to the rear side portion 213. When the flap portion 217 is listed from the front side portion 207 to place the flap portion in the second position 6000 and in the second power configuration can view a detailed view 605 of the message received by the electronic device 100. That is, the notification device 200 can provide the user with a notification 505 that the electronic device 100 coupled to the notification device 100 has received a message. The user can then manipulate the notification device 200 (for example, by placing the flap portion 207 in a second position) to view a detailed view 605 of the message received by the electronic device 100. With the notification device 200 illustrated in FIG. 2-7, even though the electronic device 100 is inserted into the enclosing portion 205 and even though the display screen and visual indicators of the electronic device 100 are obstructed while the electronic device 100 resides in the enclosing portion 205, the user can still receive notifications at the notification device 200 that the electronic device 100 has received a message. Thus, with the notification device 200, the user is less likely to miss messages, incoming calls, or other information received by the electronic device.

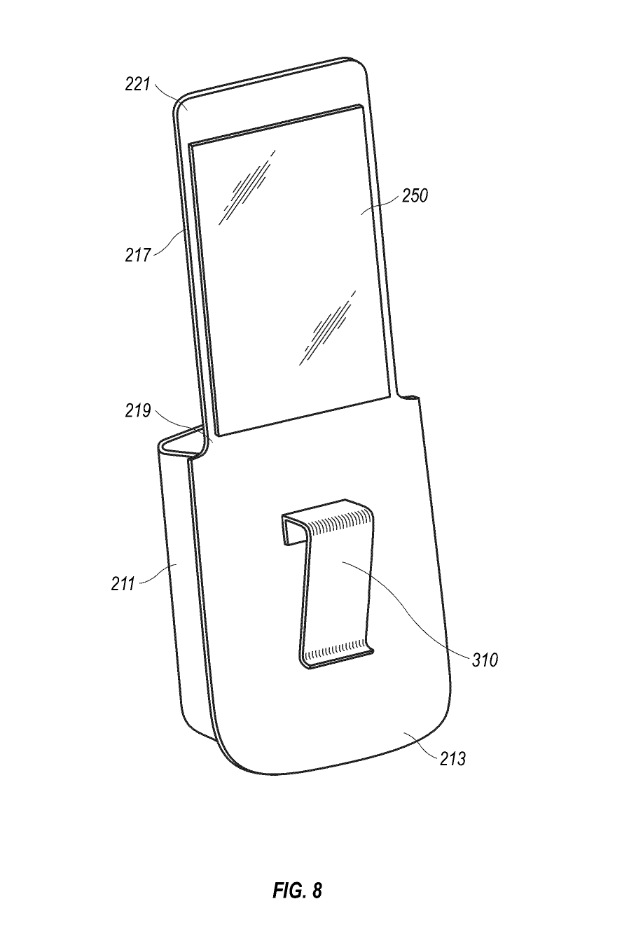

FIG. 8 illustrates the exemplary notification device 200 illustrated in FIGS. 2-7, wherein the flap portion 217 is positioned with respect to the rear side portion 213 such that the flap portion 217 forms an angle of approximately one-hundred-eighty degrees with the rear side portion 213. For example, the flap portion 217 has been positioned such that the flap portion 217 is co-linear with the rear side portion 213. In FIG. 8, the flexible display screen 250 can be placed in a third power configuration associated with this position where the flap portion 217 is co-linear with the rear side portion 213. In this third power configuration, the flexible display screen 250 can be powered down. For example, no power can be transmitted to the flexible display screen. When the flap portion 217 is positioned such that the flap portion 217 is co-linear with the rear side surface 213, the electronic device 100 can be removed from the enclosing portion 205.

FIG. 9 is another exemplary embodiment of the notification device 200 as illustrated in FIGS. 2-8, except that the flexible display screen 250 is a plurality of light emitting diodes 950. In FIG. 9, the light emitting diodes 950 can be selectively powered or illuminated to provide notifications to the user of messages received by the electronic device 100 coupled to and/or residing in the enclosing portion 205 of the notification device 200. For example, a portion of light emitting diodes 950 can be illuminated to spell the words “new messages.” In another embodiment, a portion of light emitting diodes 950 can be illuminated to spell the name of the sender of the new message.

FIGS. 10 and 11 illustrate another exemplary embodiment of a notification device in accordance with the present disclosure. FIGS. 10 and 11 illustrate a notification device 1000 which includes a wristwatch 1000. FIG. 10 is a top view of the notification device 1000. As illustrated in FIG. 10, the notification device 1000 is a wristwatch and includes a flexible display screen 1005 coupled thereto. The flexible display screen 1005 can be electrically coupled to a power source (not shown) of the wristwatch. That is, the flexible display screen 1005 can be independently powered. As the electronic flexible display screen 1005 can be independently powered, the notification device 1000 can be placed remote from the electronic device 100 and still display notifications 1010 associated with the electronic device 100. In another embodiment, the flexible display screen 1005 can be solar powered. In FIG. 10, the wristwatch 1000 can be a digital watch. The wristwatch 1000 can display the time when not showing a notification message(s).

In FIG. 10, the flexible display screen 1005 can be configured to display messages or notifications 1010 of messages received by an electronic device 100 coupled to the notification device 1000. For example, in FIG. 11, an electronic device 100 that is a smartphone is coupled to the notification device 1000. The electronic device 100 can be stored in the pocket of a user, where notifications received by the user cannot be viewed by the user when received. The notification device 1000 provides a means for notifying the user that the stored electronic device 100 has received a message. For example, a signal can be sent from the electronic device 100 to the notification device 1000 when a message is received by the electronic device 100. The signal can be transmitted via a Bluetooth connection, a near field communication connection, a wireless connection, a Wi-Fi connection, or any other connection which indirectly couples the flexible display screen 1005 to the electronic device 100. The signal can include instructions to display a notification 1010 on the flexible display screen 1005 which can notify the user that a message has been received by the electronic device 100. For example, similar to the embodiment illustrated in FIGS. 5-7, the notification 1010 can be indicative of an incoming call, a voicemail, an email, a text message, a photo, or other message received by the electronic device 100. In one embodiment, the notification 1010 can include a time and a type of message received. In another embodiment, the notification 1010 can include an indication of a number of emails received, a name or a phone number associated with the message received, a name and/or phone number of an incoming call, a subject line of a message received by the electronic device 100, a number of missed calls, a number of voicemail message, or any other notification 1010 associated with the message received by the electronic device 100. Although, not illustrated, the notification device 1000 can include a switch or button which may be actuated by the user to display a detailed view of the message on the flexible display screen 1005 when the user views the notification 1010. In FIGS. 10 and 11, even though the electronic device 100 is stored, the user can still receive notifications at the notification device 1000 that the electronic device 100 has received a message. Thus, with the notification device 1000, the user is less likely to miss messages, incoming calls, or other information received by the electronic device.

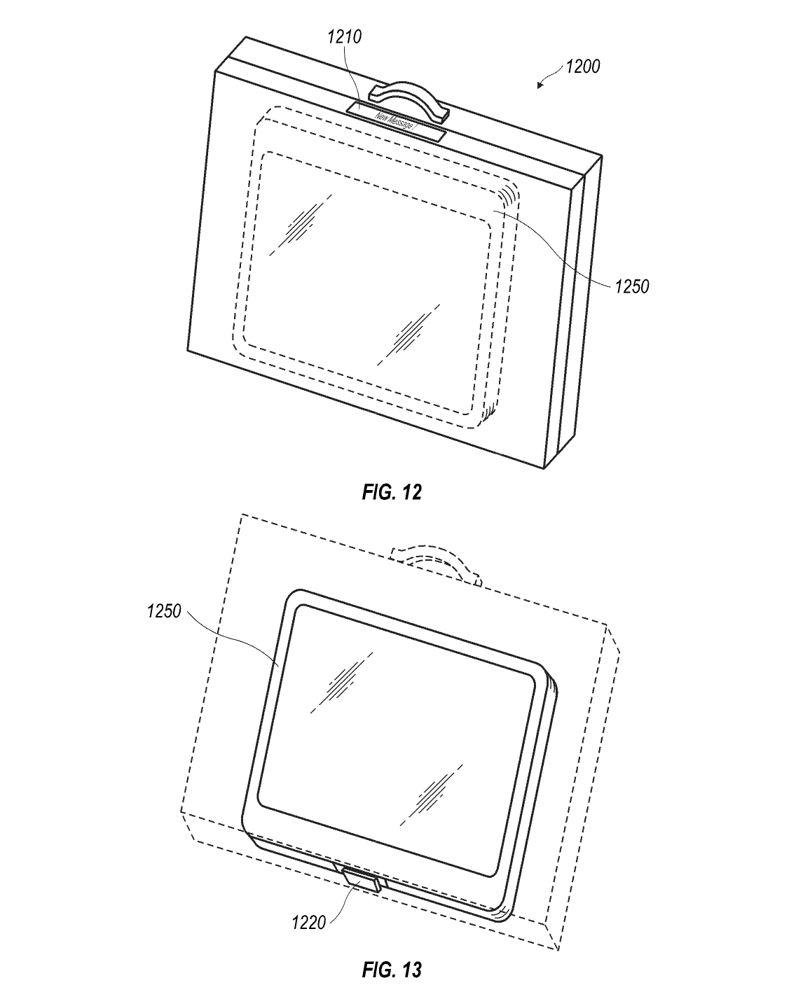

FIGS. 12 and 13 illustrate yet another embodiment of the notification device. FIGS. 12 and 13 illustrated a notification device 1200 that includes a briefcase. The briefcase includes a flexible display screen 1210 coupled to a side of the briefcase. As illustrated in FIGS. 12 and 13, a computing device 1250 resides in the briefcase. For example, the computing device 1250 can be a portable computer, a laptop, a netbook, an electronic pad, or other electronic device which can be inserted into a briefcase. As illustrated in FIG. 13, when the computing device 1250 resides in the briefcase, the computing device 1250 can be electrically coupled to an electronic device coupler 1220 of the notification device 1200. Similar to the electronic device coupler of the embodiments illustrated in FIGS. 2-8, the electronic device coupler 1220 illustrated in FIG. 13 can provide at least power from the computing device 1250 to the flexible display screen 1210. In other embodiments, the electronic device coupler 1220 can provide data from the computing device 1250 to the flexible display screen 1210. In other embodiments, the electronic device coupler 1220 can provide both power and data from the computing device 1250 to the flexible display screen. In FIGS. 12 and 13, when the computing device 1250 receives a message, for example, an email, while the computing device 1250 resides in the briefcase, a signal can be sent from the computing device 1250 to the flexible display screen 1210 to display a notification that a message has been received by the computing device 1250. Thus, even though the computing device 1250 is stored in the briefcase, the user can receive indications or notifications at the notification device 1200 that the computing device 1250 has received a message or other information. While FIGS. 12 and 13 illustrate a notification device 1200 that includes a briefcase, those of ordinary skill in the art will appreciate that the notification device 1200 can include a backpack, a laptop back, a laptop sleeve, or a handbag.

In any of the embodiments disclosed herein and illustrated in FIGS. 2-13, the notification device 200, 1000, 1200 can include more than one flexible display screen 250, 1005, 1210. For example, one flexible display screen can display a notification of receipt of a message by the electronic device 100, 1250, and another one of the more than one flexible display screen 250, 1005, 1210 can display a detailed view of the message received by the electronic device 100, 1250. For example, in an embodiment where the notification device 200 includes a mobile device holster, a first flexible display screen can be coupled to a top portion of the mobile device holster which can be viewed by the user when the holster is clipped to the user's waist or belt. The first flexible display screen can display a notification of a receipt of a message by the electronic device. A second flexible display screen can be coupled to a side portion of the mobile device holster, the side portion being longer in length than the top portion. The second flexible display screen can be configured to display a detailed view of the message received by the electronic device. For example, when a notification is displayed on the first display screen, the user can rotate the holster to view the second screen. The second flexible display screen can be powered on to display the detailed view when the user rotates the mobile device holster about the waist clip or belt clip.

Implementation of one or more embodiments may realize one or more advantages, some of which have been mentioned already. The concepts described herein can be flexibly adapted for a variety of devices, carriers and usages. The ways in which the described apparatus may be put to use are countless, and users may benefit from enhanced convenience and functionality. Some of the embodiments can be implemented at little cost in terms of size or weight, which may be important for portability,

Exemplary embodiments have been described hereinabove regarding a notification device. One of ordinary skill in the art will also appreciate that the elements and features illustrated in the embodiments described and illustrated in the figures herein can be optionally included to achieve the benefits of the presently disclosed notification device. Additionally, those skilled in the art will appreciate that features in each of the figures described herein can be combined with one another and arrange to achieve the described benefits of the presently disclosed notification device. Various modifications to and departures from the disclosed embodiments will occur to those having skill in the art. The subject matter that is intended to be within the spirit of this disclosure is set forth in the following claims.

1. A holster comprising:
an enclosing portion having a front side portion, a bottom side portion, a left side portion, a right side portion, and a rear side portion;
a flap portion having a first end coupled to the rear side portion and a second end releasably coupled to the front side portion, wherein the flap portion is moveable between two positions: a first position in which the flap portion is coupled to both the front side portion and the rear side portion and a second position in which the flap portion is coupled only to the front side portion and the second end forms an angle with the rear side portion;
a flexible exterior facing display screen covering a majority of the flap portion;
an electronic device coupler configured to electrically couple the flexible display screen to an electronic device inserted into the enclosing portion, wherein the electronic device coupler provides both data and power to the flexible display screen from the electronic device in the event the electronic device resides in the enclosing portion; and
the flexible display screen configured to display a notification of receipt of a message in the first position and a detailed view of the message in the second position.

2. The holster of claim 1, wherein the flexible display screen has a first power configuration corresponding to the first position of the flap portion and configured to power only a portion of the flexible display screen and a second power configuration wherein an entirety of the flexible display screen is powered.

3. The holster of claim 1, wherein the angle is greater than thirty degrees.

4. The holster of claim 1, wherein the flexible display screen is configured to be powered down in the event the flap portion is positioned co-linearly with the rear side portion.

5. The holster of claim 1, wherein the notification includes a time and a type of message received.

6. The holster of claim 1, wherein the notification includes an indication of an unread message.

7. The holster of claim 1, wherein the electronic device coupler is one of an induction coupler, a conductive contact pad, and a USB connector.

8. The holster of claim 1, wherein the electronic device coupler is a charging pad coupled to one of the front side portion, the bottom side portion, the left side portion, the right side portion, and the rear side portion.

9. The holster of claim 1, wherein the electronic device coupler includes two couplers, one being for power and the other for data.

10. The holster of claim 9, wherein:
the electronic device coupler for power is one of an induction coupler, a conductive contact pad, and a USB connector; and
the electronic device coupler for data is one of a Bluetooth connector, a Wi-Fi connector, and a near field communication connector.

11. The holster of claim 1, wherein the flexible display screen comprises more than one flexible display screen, wherein one of the flexible display screens is coupled to the flap portion and another one of flexible display screens is coupled to one of the front side portion, the bottom side portion, the left side portion, the right side portion, and the rear side portion, each of the flexible display screens being configured to display at least one of a notification of receipt of a message and a detailed view of the message.

12. The holster of claim 11, wherein the flexible display screen coupled to one of the front side portion, the bottom side portion, the left side portion, the right side portion, and the rear side portion is configured to display the notification of receipt of the message, and the flexible display screen coupled to the flap portion is configured to display the detailed view of the message.

13. The holster of claim 1, wherein the flexible display screen is one of a flexible light emitting diode screen, a flexible light crystal display, a flexible substrate on which more than one transistor is placed thereon, and an electronic paper display.

14. A holster for an electronic device, the holster comprising:
an enclosing portion having a front side portion, a bottom side portion, a left side portion, a right side portion, and a rear side portion;
a flap portion having a first end coupled to the rear side portion and a second end releasably coupled to the front side portion, wherein the flap portion is moveable between two positions: a first position in which the flap portion is coupled to both the front side portion and the rear side portion and a second position in which the flap portion is coupled only to the front side portion and the second end forms an angle with the rear side portion;
an electronic device coupler configured to electrically couple the flexible display screen to an electronic device inserted into the enclosing portion, wherein the electronic device coupler provides only power to the flexible display screen from the electronic device, in the event the electronic device resides in the enclosing portion; and
the flexible display screen configured to display a notification of receipt of a message in the first position and a detailed view of the message in the second position.

15. The holster of claim 14, wherein the electronic device coupler is one of an induction coupler, a conductive contact pad, and a USB connector.

16. The holster of claim 14, wherein the flexible display screen is adapted to receive signals transmitted from the electronic device to display the notification, wherein the signals are transmitted over one of a Bluetooth connection, a near field communication connection, and a Wi-Fi connection.

17. A notification device comprising:
an enclosing portion having a front side portion, a bottom side portion, a left side portion, a right side portion, and a rear side portion;
a flexible exterior facing display screen covering a majority of one of the front side portion, the bottom side portion, the left side portion, the right side portion, and the rear side portion;
an electronic device coupler configured to electrically couple the flexible display screen to an electronic device inserted into the enclosing portion, wherein the electronic device coupler provides at least one of power and data to the flexible display screen from the electronic device, in the event the electronic device resides in the enclosing portion; and
the flexible display screen configured to display a notification of receipt of a message in a first position of the flexible display screen and a detailed view of the message in a second position of the flexible display screen.

18. The notification device of claim 17, wherein the electronic device coupler provides both power and data to the flexible display screen from the electronic device.

19. The notification device of claim 17, wherein the flexible display screen is one of a flexible light emitting diode screen, a flexible light crystal display, a flexible substrate on which more than one transistor is placed thereon, and an electronic paper display.

20. The notification device of claim 17, wherein the electronic device coupler includes two couplers, one being for power and the other for data.
